(19) United States
(12) Patent Application Publication
(10) Pub. No.: US 2025/0149632 A1
(43) Pub. Date: May 8, 2025

(54) BATTERY ELECTRODE PLATE, SECONDARY BATTERY, AND ELECTRONIC APPARATUS

(71) Applicant: Dongguan Amperex Technology Limited, Dongguan (CN)

(72) Inventor: Shan ZHU, Dongguan (CN)

(73) Assignee: Dongguan Amperex Technology Limited, Dongguan (CN)

(21) Appl. No.: 18/934,688

(22) Filed: Nov. 1, 2024

(30) Foreign Application Priority Data
Nov. 2, 2023 (CN) 202311455976.3

(51) Int. Cl. H01M 10/0565; H01M 4/02

(52) U.S. Cl. CPC H01M 10/0565; H01M 2004/021; H01M 2004/027; H01M 2004/028

(57) ABSTRACT

A battery electrode plate includes a current collector and an electrode active layer disposed on at least one surface of the current collector, where the electrode active layer includes an active material, a solid electrolyte, a binder, and a conductive agent. D_{V}50 of the active material is X, and D_{V}50 of the solid electrolyte is Z, where X:Z is from 5 to 30; and based on a mass of the electrode active layer, a mass percentage of the solid electrolyte is M, where 0.3%≤M≤5%.

### CROSS-REFERENCE TO RELATED APPLICATIONS

This application claims priority to Chinese Patent Application No. 202311455976.3, filed on Nov. 2, 2023, the whole disclosure of which is incorporated herein by reference.

### TECHNICAL FIELD

This application relates to the field of energy storage technologies, and in particular, to a battery electrode plate, a secondary battery, and an apparatus.

### BACKGROUND

In lithium-ion batteries, the liquid-phase lithium-ion transport speed between the positive electrode and the negative electrode has a very significant impact on the kinetic performance of lithium-ion batteries. The speed of transport directly affects the charging and discharging rates of lithium-ion batteries, thereby influencing the power output and cycle life of the batteries. As a key component in lithium-ion batteries, acting as channels and media for lithium-ion transport. However, during the manufacturing process of the electrode plates, some issues often arise. For example, after cold pressing, many ineffective closed holes or pores may form inside the electrode plates. These closed holes not only waste space in the electrode plates, reducing energy density, but also hinder lithium-ion transport. This problem is particularly pronounced in thick electrode plates, as liquid-phase lithium-ion transport is restricted, thereby affecting the performance of the lithium-ion battery.

To address this issue, researchers have proposed several methods to promote lithium-ion transport. One method is to use pore-forming agents to introduce tiny pores or channels in the electrode plates to increase the diffusion speed of lithium ions. Another method is to use laser technology to precisely drill holes in the electrode plates to create channels that facilitate lithium-ion transport. These methods can improve the kinetic performance of the battery, but they also have drawbacks, such as significantly reducing the energy density of the lithium-ion battery.

Therefore, there is an urgent need for a new method to maximize the utilization of pores within the electrode plates, ensuring that these pores are all effective channels while reducing ineffective closed holes. This will help improve the performance of lithium-ion batteries, including enhancing the rate performance of lithium-ion batteries without sacrificing energy density. Research in this area is crucial for developing more efficient lithium-ion batteries and other battery technologies, as they play a key role in various applications, from portable electronic devices to electric vehicles.

### SUMMARY

In view of the foregoing problems in the prior art, this application proposes a battery electrode plate, a secondary battery, and an apparatus. In the electrode plate, through the introduction of a specific content of solid electrolyte and using a reasonable particle size matching between the solid electrolyte and active material particles, the number of closed holes in the electrode plate is reduced, effectively controlling the lithium-ion transport paths, thereby improving the kinetic performance of the lithium-ion battery.

According to a first aspect, this application provides a battery electrode plate, including a current collector and an electrode active layer disposed on at least one surface of the current collector, where the electrode active layer includes an active material, a solid electrolyte, a binder, and a conductive agent; where D_{V}50 of the active material is X, and D_{V}50 of the solid electrolyte is Z, where X:Z is from 5 to 30; and based on a mass of the electrode active layer, a mass percentage of the solid electrolyte is M, where 0.3%≤M≤5%. In the electrode plate, through the introduction of a specific content of solid electrolyte and using a reasonable particle size matching between the solid electrolyte and active material particles, the number of closed holes in the electrode plate is reduced, effectively controlling the lithium-ion transport paths, thereby improving the kinetic performance of the lithium-ion battery.

According to some embodiments of this application, X:Z is from 14 to 30; and 1%≤M≤5%. Lithium-ion batteries that meet these conditions have a more uniform particle size distribution, with further improved and optimized impedance and rate performance data, achieving better results.

According to one or more of the foregoing embodiments, 2 μm≤X≤20 μm. The particle size of the active material being too large or too small will both affect the compacted density of the electrode plate, thereby affecting the energy density of the cell. At the same time, the particle size of the active material being too small will lead to a larger specific surface area of the active material, increasing side reactions; and the particle size of the active material being too large will increase the solid-phase diffusion distance, affecting the kinetics of the cell.

According to one or more of the foregoing embodiments, 0.1 μm≤Z≤3 μm. The particle size of the solid electrolyte being too large or too small makes it difficult to effectively regulate the pore distribution of the active material. If the particle size is too small, existing pores of the active material will be filled without affecting the pore structure. If the particle size is too large, additional pores will be created, causing adjustment of existing pores to fail, and additionally, a relatively large volume is occupied, affecting the compacted density of the electrode plate and thus affecting the energy density.

According to one or more of the foregoing embodiments, D_{V}10 of the solid electrolyte is E, where 0.03 μm≤E≤0.5 μm; and D_{V}99 of the solid electrolyte is F, where 0.8 μm≤F≤8 μm.

According to one or more of the foregoing embodiments, D_{V}10 of the solid electrolyte is E, where Z:E is from 3 to 10; and D_{V}99 of the solid electrolyte is F, where F:Z is from 3 to 10. The particle size range of the solid electrolyte that can play a regulatory role is relatively fixed. If the particle size distribution of the solid electrolyte is too wide, the content of the actual solid electrolyte that effectively regulates pore distribution will be reduced.

According to one or more of the foregoing embodiments, the battery electrode plate is a positive electrode plate, the active material is a positive electrode active material, and the positive electrode active material includes at least one of lithium cobalt oxide, lithium nickel cobalt manganese oxide, lithium manganese oxide, lithium iron phosphate, or lithium manganese iron phosphate.

According to one or more of the foregoing embodiments, in the positive electrode plate, the solid electrolyte includes oxide solid electrolyte or metal halide solid electrolyte.

According to one or more of the foregoing embodiments, the oxide solid electrolyte includes at least one of perovskite-type, anti-perovskite-type, garnet-type, NASICON-type, LISICON-type, or LiPON (lithium phosphorus oxygen nitrogen)-type.

According to one or more of the foregoing embodiments, the perovskite-type is preferably Li₃ₓLa_{(2/3)-x}□_{(1/3)-2x}TiO₃ (abbreviated as LLTO, where represents a vacancy site in the lattice, and 0<x<⅙); the anti-perovskite-type is preferably Li₃OCl; the garnet-type (Garnet) is preferably Li₇La₃Zr₂O₁₂; the NASICON-type is preferably Li₁₊ₓAlₓGe₂₋ₓ(PO₄)₃ (abbreviated as LAGP, and 0<x<2) or Li₁₊ₓAlₓTi₂₋ₓ(PO₄)₃ (abbreviated as LATP, and 0<x<2); and the LISICON-type is preferably Li₁₆₋₂ₓMₓ(TO₄)₄(0<x<8, where M represents Mg or Zn; and T represents Si or Ge).

According to one or more of the foregoing embodiments, the metal halide solid electrolyte is preferably at least one of Li₃YBr_{5.7}F_{0.3}, Li₂ZrCl₆, or Li₃ScCl₆.

According to one or more of the foregoing embodiments, the battery electrode plate is a negative electrode plate, the active material is a negative electrode active material, and the negative electrode active material is selected from at least one of graphite, silicon, silicon alloy, or tin alloy.

According to one or more of the foregoing embodiments, in the negative electrode plate, the solid electrolyte includes oxide solid electrolyte or metal halide

According to one or more of the foregoing embodiments, the oxide solid electrolyte is preferably LLZO (lithium lanthanum zirconium oxide) or LiPON (lithium phosphorus oxygen nitrogen).

According to one or more of the foregoing embodiments, the metal halide solid electrolyte is preferably at least one of Li₃YBr_{5.7}F_{0.3}, Li₂ZrCl₆, or Li₃ScCl₆.

According to one or more of the foregoing embodiments, D_{V}10 of the positive electrode active material is A, where 0.7 μm≤A≤3 μm; D_{V}99 of the positive electrode active material is B, where 7 μm≤B≤45 μm; and A<F.

According to one or more of the foregoing embodiments, D_{V}10 of the negative electrode active material is C, where 0.5 μm≤C≤6 μm; D_{V}99 of the negative electrode active material is D, where 6 μm≤D≤50 μm; and C<F.

According to one or more of the foregoing embodiments, conductivity of the solid electrolyte is N, where N≥0.1 mS/cm. If the conductivity is too low, it will lead to a decline in the kinetic performance of the lithium-ion battery.

According to a second aspect, this application provides a secondary battery, including the battery electrode plate of the first aspect.

According to a third aspect, this application provides an apparatus, including the secondary battery of the second aspect.

Beneficial effects are as follows:

In the electrode plate in this application, through the introduction of a specific content of solid electrolyte and using a reasonable particle size matching between the active material and the solid electrolyte, the utilization of pores within the electrode plate is maximized, ensuring these pores are effective channels while reducing ineffective closed holes. This solution can implement effective control of the lithium-ion transport paths, improving the kinetic performance of lithium-ion batteries. In particular, it significantly improves the impedance and enhances the rate performance of lithium-ion batteries without compromising energy density.

### BRIEF DESCRIPTION OF DRAWINGS

FIG. 1 is a schematic diagram of particle size distribution of the active material and solid electrolyte in example 1 of this application.

FIG. 2 is a comparison diagram of the EIS of the electrode plate with the introduction of solid electrolyte in example 1 of this application and the EIS of the electrode plate without the introduction of solid electrolyte in comparative example 1 of this application.

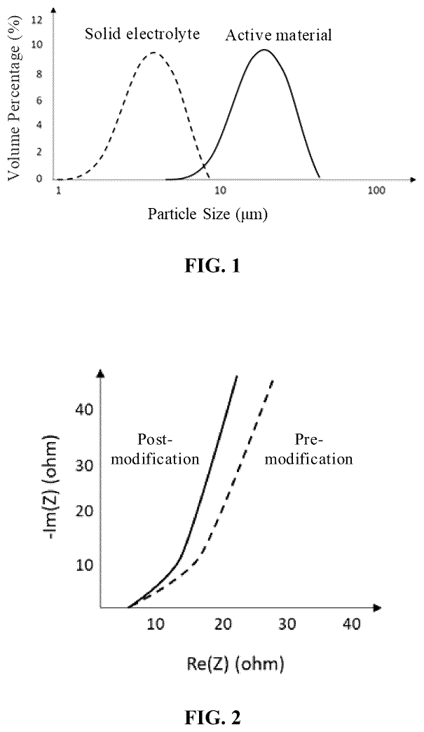

### DETAILED DESCRIPTION

To make the objectives, technical solutions, and advantages of this application clearer, the following clearly and completely describes the technical solutions in this application with reference to the embodiments. Apparently, the described embodiments are some but not all of the embodiments of this application. The embodiments described herein are illustrative and used to provide a basic understanding of this application. Some embodiments of this application should not be construed as limitations on this application.

For brevity, this specification specifically discloses only some numerical ranges. However, any lower limit may be combined with any upper limit to form a range not expressly recorded; any lower limit may be combined with any other lower limit to form a range not expressly recorded; and any upper limit may be combined with any other upper limit to form a range not expressly recorded. In addition, each individually disclosed point or individual single numerical value may itself be a lower limit or an upper limit which can be combined with any other point or individual numerical value or combined with another lower limit or upper limit to form a range not expressly recorded.

In the descriptions of this specification, “more than” or “less than” is inclusive of the present number unless otherwise specified.

Unless otherwise specified, the terms used in this application have well known meanings commonly understood by persons skilled in the art. Unless otherwise specified, numerical values of parameters mentioned in this application may be measured by using various measurement methods commonly used in the art (for example, testing may be performed by using a method provided in the embodiments of this application).

In the specific embodiments and claims, an item list connected by the terms “at least one of”, “at least one piece of”, “at least one kind of” or other similar terms may mean any combination of the listed items. For example, if items A and B are listed, the phrase “at least one of A or B” means only A; only B; or A and B. In another example, if items A, B, and C are listed, the phrase “at least one of A, B, or C” means only A; only B; only C; A and B (exclusive of C); A and C (exclusive of B); B and C (exclusive of A); or all of A, B, and C. The item A may contain a single element or a plurality of elements. The item B may contain a single element or a plurality of elements. The item C may contain a single element or a plurality of elements.

According to a first aspect, this application provides a battery electrode plate, including a current collector and an electrode active layer disposed on at least one surface of the current collector, where the electrode active layer includes an active material, a solid electrolyte, a binder, and a conductive agent; where D_{V}50 of the active material is X, and D_{V}50 of the solid electrolyte is Z, where X:Z is from 5 to 30; and based on a mass of the electrode active layer, a mass percentage of the solid electrolyte is M, where 0.3%≤M≤5%. In the electrode plate, through the introduction of a specific content of solid electrolyte and using a reasonable particle size matching between the solid electrolyte and active material particles, the number of closed holes in the electrode plate is reduced, effectively controlling the lithium-ion transport paths, thereby improving the kinetic performance of the lithium-ion battery.

According to some embodiments of this application, X:Z may be 5, 10, 15,20, 25, 30or in a range of any two of these values. M may be 0.3%, 0.5%, 1%, 1.5%, 2%, 2.5%, 3%, 3.5%, 4%, 4.5%, or 5%, or in a range of any two of these values. In some embodiments, X:Z is from 14 to 30; and 1%≤M≤5%. Lithium-ion batteries that meet these conditions have a more uniform particle size distribution, with further improved and optimized impedance and rate performance data, achieving better results.

According to some embodiments of this application, 2 μm≤X≤20 μm. In some embodiments, X may be 2 μm, 4 μm, 6 μm, 8 μm, 10 μm, 12 μm, 14 μm, 16 μm, 18 μm, or 20 μm, or in a range of any two of these values. The particle size of the active material being too large or too small will both affect the compacted density of the electrode plate, thereby affecting the energy density of the cell. At the same time, the particle size of the active material being too small will lead to a larger specific surface area of the active material, increasing side reactions; and the particle size of the active material being too large will increase the solid-phase diffusion distance, affecting the kinetics of the cell.

According to some embodiments of this application, 0.1 μm≤Z≤3 μm. In some embodiments, Z may be 0.1 μm, 0.3 μm, 0.5 μm, 0.7 μm, 0.9 μm, 1.0 μm, 1.2 μm, 1.4 μm, 1.6 μm, 1.8 μm, 2.0 μm, 2.2 μm, 2.4 μm, 2.6 μm, 2.8 μm, or 3.0 μm, or in a range of any two of these values. The particle size of the solid electrolyte being too large or too small makes it difficult to effectively regulate the pore distribution of the active material. If the particle size is too small, existing pores of the active material will be filled without affecting the pore structure. If the particle size is too large, additional pores will be created, causing adjustment of existing pores to fail, and additionally, a relatively large volume is occupied, affecting the compacted density of the electrode plate and thus affecting the energy density.

According to some embodiments of this application, D_{V}10 of the solid electrolyte is E, where 0.03 μm≤E≤0.5 μm. In some embodiments, E may be 0.03 μm, 0.05 μm, 0.1 μm, 0.15 μm, 0.20 μm, 0.25 μm, 0.3 μm, 0.35 μm, 0.4 μm, 0.45 μm, or 0.5 μm, or in a range of any two of these values. D_{V}99 of the solid electrolyte is F, where 0.8 μm≤F≤8 μm. In some embodiments, F may be 0.8 μm, 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, or 8 μm, or in a range of any two of these values.

According to some embodiments of this application, D_{V}10 of the solid electrolyte is E, where Z:E is from 3 to 10. Z:E may be 3, 4, 5, 6, 7, 8, 9, or 10, or in a range of any two of these values. D_{V}99 of the solid electrolyte is F, where F:Z is from 3 to 10. F:Z may be 3, 4, 5, 6, 7, 8, 9, or 10, or in a range of any two of these values. The particle size range of the solid electrolyte that can play a regulatory role is relatively fixed. If the particle size distribution of the solid electrolyte is too wide, the content of the actual solid electrolyte that effectively regulates pore distribution will be reduced.

According to some embodiments of this application, the battery electrode plate is a positive electrode plate, the active material is a positive electrode active material, and the positive electrode active material includes at least one of lithium cobalt oxide, lithium nickel cobalt manganese oxide, lithium manganese oxide, lithium iron phosphate, or lithium manganese iron phosphate.

According to some embodiments of this application, in the positive

electrode plate, the solid electrolyte includes oxide solid electrolyte and metal halide solid electrolyte.

According to some embodiments of this application, the oxide solid electrolyte includes at least one of perovskite-type, anti-perovskite-type, garnet-type, NASICON-type, LISICON-type, or LiPON-type.

According to some embodiments of this application, the perovskite-type is preferably Li₃ₓLa_{(2/3)-x}□_{(1/3)-2x}TiO₃ (abbreviated as LLTO, where represents a vacancy site in the lattice, and 0<x<⅙); the anti-perovskite-type is preferably Li₃OCl; the garnet-type (Garnet) is preferably Li₇La₃Zr₂O₁₂; the NASICON-type is preferably Li₁₊ₓAlₓGe₂₋ₓ(PO₄)₃ (abbreviated as LAGP, and 0<x<2) or Li₁₊ₓAlₓTi₂₋ₓ(PO₄)₃ (abbreviated as LATP, and 0<x<2); and the LISICON-type is preferably Li₁₆₋₂ₓMₓ(TO₄)₄ (0<x<8, where M represents Mg or Zn; and T represents Si or Ge).

According to some embodiments of this application, the metal halide solid electrolyte is preferably at least one of Li₃YBr_{5.7}F_{0.3}, Li₂ZrCl₆, or Li₃ScCl₆.

According to some embodiments of this application, the battery electrode plate is a negative electrode plate, the active material is a negative electrode active material, and the negative electrode active material is selected from at least one of graphite, silicon, silicon alloy, or tin alloy.

According to some embodiments of this application, in the negative electrode plate, the solid electrolyte includes oxide solid electrolyte or metal halide

According to some embodiments of this application, the oxide solid electrolyte is preferably LLZO or LiPON.

According to some embodiments of this application, the metal halide solid electrolyte is preferably at least one of Li₃YBr_{5.7}F_{0.3}, Li₂ZrCl₆, or Li₃ScCl₆.

According to some embodiments of this application, D_{V}10 of the positive electrode active material is A, where 0.7 μm≤A≤3 μm. In some embodiments, A may be 0.7 μm, 0.9 μm, 1.0 μm, 1.2 μm, 1.4 μm, 1.6 μm, 1.8 μm, 2.0 μm, 2.2 μm, 2.4 μm, 2.6 μm, 2.8 μm, or 3.0 μm, or in a range of any two of these values. D_{V}99 of the positive electrode active material is B, where 7 μm≤B≤45 μm. B may be 7 μm, 10 μm, 15 μm, 20 μm, 25 μm, 30 μm, 35 μm, 40 μm, or 45 μm, or in a range of any two of these values. According to some embodiments of this application, A<F.

According to some embodiments of this application, D_{V}10 of the negative electrode active material is C, where 0.5 μm≤C≤6 μm. C may be 0.5 μm, 1 μm, 1.5 μm, 2 μm, 2.5 μm, 3 μm, 3.5 μm, 4 μm, 4.5 μm, 5 μm, 5.5 μm, or 6 μm, or in a range of any two of these values. D_{V}99 of the negative electrode active material is D, where 6 μm≤D≤50 μm. D may be 6 μm, 10 μm, 15 μm, 20 μm, 25 μm, 30 μm, 35 μm, 40 μm, 45 μm, or 50 μm, or in a range of any two of these values. According to some embodiments of this application, C<F.

According to some embodiments of this application, conductivity of the solid electrolyte is N, where N≥0.1 mS/cm. If the conductivity is too low, it will lead to a decline in the kinetic performance.

According to some embodiments of this application, in the positive electrode plate, the binder includes, but is not limited to: polyvinyl alcohol, hydroxypropyl cellulose, diacetyl cellulose, polyvinyl chloride, carboxylated polyvinyl chloride, polyvinyl pyrrolidone, polyurethane, polytetrafluoroethylene, polyvinylidene fluoride, vinylidene fluoride-hexafluoropropylene copolymer, and the like. In some embodiments, the conductive agent includes, but is not limited to: carbon-based materials, metal-based materials, conductive polymers, and a mixture thereof. In some embodiments, the carbon-based material is selected from carbon black, acetylene black, Ketjenblack, carbon nanotubes, carbon fibers, graphene, or any combination thereof. In some embodiments, the metal-based material is selected from metal powder or metal fibers.

According to some embodiments of this application, the positive electrode current collector may be a metal foil or a composite current collector. For example, an aluminum foil may be used. The composite current collector may be formed by forming a metal material (copper, copper alloy, nickel, nickel alloy, titanium, titanium alloy, silver, silver alloy, or the like) on a polymer matrix.

According to some embodiments of this application, in the negative electrode plate, the binder includes, but is not limited to at least one of: polyamide, polyacrylonitrile, an acrylate polymer, polyacrylic acid, polyacrylate, sodium carboxymethyl cellulose, polyvinyl pyrrolidone, polyvinyl ether, styrene-butadiene rubber, and the like. In some embodiments, the conductive agent may use any conductive material as long as it does not cause a chemical change. In some embodiments, the conductive agent includes at least one of conductive carbon black, acetylene black, carbon nanotubes, Ketjenblack, carbon fibers, or graphene.

According to this embodiment of this application, the negative electrode current collector may be copper foil, nickel foil, stainless steel foil, titanium foil, nickel foam, copper foam, a polymer substrate coated with a conductive metal, or a combination thereof.

According to a second aspect, this application provides a secondary battery, including the battery electrode plate of the first aspect.

According to some embodiments of this application, the secondary battery further includes an electrolyte, where the electrolyte includes a lithium salt and a non-aqueous solvent.

In some embodiments of this application, the lithium salt is selected from one or more of a group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, the lithium salt may be LiPF₆.

According to some embodiments of this application, the non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An instance of the linear carbonate compound is dimethyl carbonate (DMC), diethyl carbonate (DEC), dipropyl carbonate (DPC), methyl propyl carbonate (MPC), ethylene propyl carbonate (EPC), methyl ethyl carbonate (MEC), or a combination thereof. An instance of the cyclic carbonate compound is ethylene carbonate (EC), propylene carbonate (PC), butylene carbonate (BC), vinyl ethylene carbonate (VEC), and a combination thereof. An instance of the fluorocarbonate compound is fluoroethylene carbonate (FEC), 4,5-difluoro-1,3-dioxolan-2-one, 4,4-difluoro-1,3-dioxolan-2-one, 4,4,5-trifluoro-1,3-dioxolan-2-one, 4,4,5,5-tetrafluoro-1,3-dioxolan-2-one, 4-fluoro-5-methyl-1,3-dioxolan-2-one, 4-fluoro-4-methyl-1,3-dioxolan-2-one, 4,5-difluoro-4-methyl-1,3-dioxolan-2-one, 4,4,5-trifluoro-5-methyl-1,3-dioxolan-2-one, 4-trifluoroMethyl ethylence carbonate, and a combination thereof.

An instance of the carboxylate compound is methyl formate, methyl acetate, ethyl acetate, n-propyl acetate, tert-butyl acetate, methyl propionate, ethyl propionate, propyl propionate, γ-butyrolactone, decanolide, valerolactone, caprolactone, and a combination thereof.

An instance of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, and a combination thereof.

An instance of the another organic solvent is dimethyl sulfoxide, 1,2-dioxolane, sulfolane, methyl-sulfolane, 1,3-dimethyl-2-imidazolidinone, N-methyl-2-pyrrolidone, methylamide, dimethylformamide, acetonitrile, trimethyl phosphate, triethyl phosphate, trioctyl phosphate, phosphate ester, and a combination thereof.

The electrolyte further includes an additive, where the additive is selected from at least one of fluorinated ethylene carbonate, vinylene carbonate, 1,3-propane sultone, 1,4-butane sultone, 1,3-propylene sultone, vinyl sulfate, propylene sulfate, propane sultone (PS), ethanedinitrile, malononitrile, or glutaronitrile. The positive electrode additive in the electrolyte can stabilize the positive electrode material, prevent its side reactions with the electrolyte, and improve the high voltage and high temperature performance of the battery cell; and the negative electrode additive mainly forms a stable SEI on the negative electrode, reducing the consumption of the electrolyte and improving the cycle stability of the battery cell.

According to some embodiments of this application, in the secondary battery, a separator is provided between the positive electrode and the negative electrode to prevent short circuits. A material and shape of the separator used in the embodiments of this application is not specifically limited, and any technology disclosed in the prior art may be used for the separator. In some embodiments, the separator includes a polymer or an inorganic substance formed by a material stable to the electrolyte of this application. For example, the separator may include a substrate layer and a surface treatment layer. The substrate layer is a non-woven fabric, film, or composite film of a porous structure. The substrate layer is made of at least one of polyethylene, polypropylene, polyethylene terephthalate, or polyimide. Specifically, a polypropylene porous film, a polyethylene porous film, polypropylene non-woven fabric, polyethylene non-woven fabric, or a polypropylene-polyethylene-polypropylene porous composite film may be selected. The surface treatment layer is provided on at least one surface of the substrate layer, and the surface treatment layer may be a polymer layer or an inorganic substance layer, or may be a layer formed by mixing a polymer and an inorganic substance. The inorganic substance layer includes an inorganic particle and a binder. The inorganic particle includes at least one of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder includes at least one of polyvinylidene fluoride, a vinylidene fluoride-hexafluoropropylene copolymer, polyamide, polyacrylonitrile, acrylate polymer, polyacrylic acid, polyacrylate, polyvinylpyrrolidone, polyvinyl ether, polymethyl methacrylate, polytetrafluoroethylene, or polyhexafluoropropylene. The polymer layer includes a polymer, and a material of the polymer includes at least one of polyamide, polyacrylonitrile, acrylate polymer, polyacrylic acid, polyacrylate, polyvinylpyrrolidone, polyvinyl ether, polyvinylidene fluoride, or a vinylidene fluoride-hexafluoropropylene copolymer.

According to some embodiments of this application, the secondary battery in this application is a lithium secondary battery. In some embodiments, the lithium secondary battery includes, but is not limited to: a lithium metal secondary battery, a lithium-ion secondary battery, a lithium polymer secondary battery or a lithium-ion polymer secondary battery.

According to a third aspect, the apparatus of this application may be any apparatus that uses the secondary battery of the second aspect of this application.

In some embodiments, the apparatus includes but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, or a lithium-ion capacitor.

### EXAMPLES AND COMPARATIVE EXAMPLES

Below, this application will be further specifically described with examples and comparative examples, and this application is not limited to these examples as long as the essence of this application is not departed from.

### Preparation of Pouch Lithium-Ion Battery

### Example 1

### (1) Preparation of Positive Electrode Plate

The positive electrode active material lithium cobalt oxide (LCO), solid

electrolyte LATP (lithium aluminum titanium phosphate), conductive agent carbon black, and binder polyvinylidene fluoride (PVDF) were dissolved in an N-methyl-2-pyrrolidone (NMP) solution at a mass ratio of 94.6:3:1.1:1.3 to form a positive electrode slurry. For LCO, D_{V}50 was 13 μm, D_{V}10 was 3 μm, and D_{V}99 was 18 μm; and for LATP, D_{V}50 was 0.7 μm, D_{V}10 was 0.1 μm, D_{V}99 was 2.8 μm, D_{V}99/D_{V}50=4, and D_{V}50/D_{V}10=7, where D_{V}50 (LCO)/D_{V}50 (LATP)=19. Aluminum foil was used as the positive electrode current collector. The positive electrode slurry was applied on both sides of the aluminum foil, with a single-side coating weight of 229 mg/1540.25 mm². The electrode plate has a width of 80 mm, and a length of 1500 mm, which was then dried, cold-pressed, and subjected to cutting and welding of the tabs to obtain the positive electrode plate.

### (2) Preparation of Negative Electrode Plate

The negative electrode active material artificial graphite (C), conductive agent carbon black, and binder styrene-butadiene rubber were dissolved in deionized water at a mass ratio of 97.5:0.5:2 to form a negative electrode slurry. Copper foil was used as the negative electrode current collector. The negative electrode slurry was applied on both sides of the copper foil, with a single-side coating weight of 117.5 mg/1540.25 mm². The electrode plate has a width of 82 mm, and a length of 1505 mm, which was then dried, cold-pressed, and subjected to cutting and welding of the tabs to obtain the negative electrode plate.

### (3) Preparation of Electrolyte

In an environment with a water content less than 10 ppm, lithium hexafluorophosphate (LiPF₆) and a non-aqueous organic solvent were used to prepare a base electrolyte, where the non-aqueous organic solvent was prepared by using ethylene carbonate (EC), propylene carbonate (PC), ethyl propionate (EP), and diethyl carbonate (DEC) at a mass ratio of 1:1:1:1, with a LiPF₆ concentration of 1.15 mol/L, and then positive and negative electrode additives were added. Based on a mass of the electrolyte, the positive electrode additives acetonitrile, and malononitrile each had a mass percentage of 1%, and the negative electrode additive fluorinated ethylene carbonate (FEC) had a mass percentage of 3%.

### (4) Preparation of Separator

The separator included a substrate layer and a coating layer, where 8 μm thick polyethylene (PE) was used as the substrate layer. Two sides of the substrate layer were each coated with a 2 μm aluminum oxide ceramic layer, and ultimately, two sides coated with the ceramic layer were each coated with a 2.5 mg binder polyvinylidene fluoride (PVDF), followed by drying.

### (5) Preparation of Lithium-Ion Battery

The positive electrode plate, the separator, and the negative electrode plate were stacked in sequence, such that the separator was sandwiched between the positive electrode plate and the negative electrode plate for separation, and the stacked product was wound to obtain an electrode assembly. The electrode assembly was put in an outer package aluminum-plastic film, and was dehydrated at 80° C. Then, the foregoing electrolyte was injected and packaging was performed, followed by processes such as formation, degassing, and trimming to obtain a lithium-ion battery.

### Examples 2-7

For the preparation method of the lithium-ion batteries provided in examples 2-7 can refer to example 1. The differences are as follows:

In example 2, the mass percentage of the solid electrolyte in the positive electrode active material was adjusted, with other data the same as in example 1. See Table 1 below.

In examples 3-6, the particle size distribution of the solid electrolyte and its mass percentage in the positive electrode active material were adjusted, with other data the same as in example 1. See Table 1 below.

In example 7, the type and particle size distribution of the positive electrode active material were adjusted, and at the same time, the particle size distribution of the solid electrolyte and its mass percentage in the positive electrode active material were adjusted. See Table 1 below.

### Comparative Examples 1-6

For the preparation method of the lithium-ion batteries provided in comparative examples 1-6, you can refer to examples 1-7. The differences are as follows:

In comparative example 1, no solid electrolyte was added, with other data the same as in example 1.

In comparative examples 2-5, the particle size distribution of the solid electrolyte and its mass percentage in the positive electrode active material were adjusted, with other data the same as in example 1. See Table 1 below.

In comparative example 6, no solid electrolyte was added, with other data the same as in example 7.

### Example 8

For the preparation method of the lithium-ion batteries provided in example 8, you can refer to example 1. The differences are as follows:

### (1) Preparation of Positive Electrode Plate

The positive electrode active material lithium cobalt oxide (LCO), conductive agent carbon black, and binder polyvinylidene fluoride (PVDF) were dissolved in an N-methyl-2-pyrrolidone (NMP) solution at a mass ratio of 97.6:1.1:1.3 to form a positive electrode slurry. For LCO, D_{V}50 was 13 μm, D_{V}10 was 3 μm, and D_{V}99 was 18 μm. Aluminum foil was used as the positive electrode current collector. The positive electrode slurry was applied on both sides of the aluminum foil, with a single-side coating weight of 229 mg/1540.25 mm². The electrode plate has a width of 80 mm, and a length of 1500 mm, which was then dried, cold-pressed, and subjected to cutting and welding of the tabs to obtain the positive electrode plate.

### (2) Preparation of Negative Electrode Plate

The negative electrode active material artificial graphite (C), solid electrolyte LLZO (lithium lanthanum zirconium oxide), conductive agent carbon black, and binder styrene-butadiene rubber were dissolved in deionized water at a mass ratio of 94.5:3:0.5:2 to form a negative electrode slurry. For the artificial graphite, D_{V}50 was 14 μm, D_{V}10 was 6 μm, and D_{V}99 was 25 μm; and for LATP, D_{V}50 was 0.8 μm, D_{V}99 was 7 μm, D_{V}99/D_{V}50=8.75, and D_{V}50/D_{V}10=8.0, where D_{V}50 (C)/D_{V}50 (LATP)=18. Copper foil was used as the negative electrode current collector. The negative electrode slurry was applied on both sides of the copper foil, with a single-side coating weight of 117.5 mg/1540.25 mm². The electrode plate has a width of 82 mm, and a length of 1505 mm, which was then dried, cold-pressed, and subjected to cutting and welding of the tabs to obtain the negative electrode plate.

### Examples 9-14

For the preparation method of the lithium-ion batteries provided in examples 9-14, you can refer to example 8. The differences are as follows:

In example 9, the mass percentage of the solid electrolyte in the negative electrode active material was adjusted, with other data the same as in example 8. See Table 2 below.

In examples 10-13, the particle size distribution of the solid electrolyte and its mass percentage in the negative electrode active material were adjusted, with other data the same as in example 8. See Table 2 below.

In example 14, the type and particle size distribution of the negative electrode active material were adjusted, and at the same time, the particle size distribution of the solid electrolyte and its mass percentage in the negative electrode active material were adjusted. See Table 2 below.

### Comparative Examples 7-12

In comparative example 7, no solid electrolyte was added, with other data the same as in example 8.

In comparative examples 8-11, the particle size distribution of the solid electrolyte and its mass percentage in the negative electrode active material were adjusted, with other data the same as in example 8. See Table 2 below.

In comparative example 12, no solid electrolyte was added, with other data the same as in example 14.

### Example 15

For the preparation method of the lithium-ion batteries provided in example 15, you can refer to example 1. The differences are as follows:

### (1) Preparation of Positive Electrode Plate

The positive electrode active material lithium cobalt oxide (LCO), solid electrolyte LLTO, conductive agent carbon black, and binder polyvinylidene fluoride (PVDF) were dissolved in an N-methylpyrrolidone (NMP) solution at a mass ratio of 94.6:3:1.1:1.3 to form a positive electrode slurry. For LCO, D_{V}50 was 13 μm, D_{V}10 was 3 μm, and D_{V}99 was 18 μm; and for LATP, D_{V}50 was 0.7 μm, D_{V}10 was 0.1 μm, D_{V}99 was 2.8 μm, D_{V}99/D_{V}50=4, and D_{V}50/D_{V}10=7, where D_{V}50 (LCO)/D_{V}50 (LATP)=19. Aluminum foil was used as the positive electrode current collector. The positive electrode slurry was applied on both sides of the aluminum foil, with a single-side coating weight of 229 mg/1540.25 mm². The electrode plate has a width of 80 mm, and a length of 1500 mm, which was then dried, cold-pressed, and subjected to cutting and welding of the tabs to obtain the positive electrode plate.

### (2) Preparation of Negative Electrode Plate

The negative electrode active material artificial graphite (C), solid electrolyte LLZO, conductive agent carbon black, and binder styrene-butadiene rubber were dissolved in deionized water at a mass ratio of 94.6:3:1.1:1.3 to form a negative electrode slurry. For the artificial graphite, D_{V}50 was 14 μm, D_{V}10 was 6 μm, and D_{V}99 was 25 μm; and for LATP, D_{V}50 was 0.8 μm, D_{V}99 was 7 μm, D_{V}99/D_{V}50=8.75, and D_{V}50/D_{V}10=8.0, where D_{V}50 (C)/D_{V}50 (LATP)=18. Copper foil was used as the negative electrode current collector. The negative electrode slurry was applied on both sides of the copper foil, with a single-side coating weight of 117.5 mg/1540.25 mm². The electrode plate has a width of 82 mm, and a length of 1505 mm, which was then dried, cold-pressed, and subjected to cutting and welding of the tabs to obtain the negative electrode plate.

### Comparative Example 13

In comparative example 13, no solid electrolyte was added to either the positive electrode plate or the negative electrode plate, with other data the same as in example 15. See Table 3 and Table 4 below.

### Test Method

### 1. Ion Impedance Test

Take a fresh positive electrode plate, assemble the fresh positive electrode plate with another positive electrode plate into a symmetric cell. Perform electrochemical impedance spectroscopy (EIS) test at 25° C. to obtain the ion impedance of the positive electrode plate.

### 2. Particle Size Distribution Test

Pulverize the electrode plates (by sintering or solvent soaking) and test the particle size distribution using a Malvern particle size analyzer. First, measure the mixed particle size distribution. Based on the mixed particle size distribution, determine the sieve mesh size. After sieving, test the particle size distribution again to separately measure the particle size distribution of the solid electrolyte and the active material. Use cross-sectional EDS test to determine the content of specific elements in the materials, and thereby determine the ratio of the solid electrolyte to the active material.

### 3. Lithium Precipitation Test at 25° C.

First, discharge the lithium-ion battery to a fully discharged state. Then, set a specific temperature (for example, 25° C.). Based on the design of the lithium-ion battery, perform conventional charging (constant current+constant voltage) at different rates, such as 1 C, 1.1 C, 1.2 C, and the like, which means to charge at a specific rate until the lithium-ion battery reaches its rated voltage. Then, perform constant voltage charging until 0.05 C is reached and stop charging. After charging, discharge fully at 0.2 C. Repeat the above charge-discharge cycle for 10 cycles. Finally, disassemble the fully charged lithium-ion battery and observe whether lithium precipitation occurs on the negative electrode plate. A maximum current at which no lithium precipitation occurs (no white spots exist on the surface of the negative electrode plate) is defined as the maximum no-lithium-precipitation rate of the lithium-ion battery, also known as the lithium precipitation window.

### 4. Rate Performance Test at 2 C

Leave the lithium-ion battery standing for 30 minutes at 25° C. Charge it at a constant current at a rate of 0.5 C until the rated voltage is reached, then continue with constant voltage charging until the charge-discharge rate reaches 0.05 C and stop charging. After fully charging, perform discharging at different rates (0.1 C and 2 C). The ratio of the discharge capacity at 2 C to the discharge capacity at 0.1 C is defined as the rate discharge performance.

### Test Results

TABLE 1

| | Solid Electrolyte | | | | | | | | | | | D_{V}50 Ratio | | |
|---|---|---|---|---|---|---|---|---|---|---|---|---|---|---|
| | | | | | | Mass | | | | | | D_{V}50 of | | |
| | | | | | | Percentage | | | | | | Positive | | |
| | | | | | | of Solid | | | | | | Electrode | Performance | |
| | | | | | | Electrolyte in | | Positive Electrode | | | | Active | | Rate |
| | | | | | | Positive Electrode | | Active Material | | | | Material/ | Imped- | perfor- |
| | Material | D_{V}10 | D_{V}50 | D_{V}99 | D_{V}50/ | Active Layer M | D_{V}99/ | Material | D_{V}10 | D_{V}50 | D_{V}99 | D_{V}50 of Solid | ance | mance |
| | Type | (μm) | (μm) | (μm) | D_{V}10 | (%) | D_{V}50 | Type | (μm) | (μm) | (μm) | Electrolyte | (mohm) | (2 C) |
| Example 1 | LATP | 0.1 | 0.7 | 2.8 | 7 | 3 | 4 | LCO | 3 | 13 | 18 | 19 | 62 | 93% |
| Example 2 | LATP | 0.1 | 0.7 | 2.8 | 7 | 1 | 4 | LCO | 3 | 13 | 18 | 19 | 65 | 91% |
| Example 3 | LATP | 0.5 | 2.6 | 8 | 5.2 | 0.3 | 3.1 | LCO | 3 | 13 | 18 | 5 | 69 | 88% |
| Example 4 | LATP | 0.3 | 1.3 | 5 | 4.3 | 1 | 3.8 | LCO | 3 | 13 | 18 | 10 | 67 | 90% |
| Example 5 | LATP | 0.2 | 0.9 | 4.5 | 4.5 | 2 | 5 | LCO | 3 | 13 | 18 | 14 | 65 | 91% |
| Example 6 | LATP | 0.08 | 0.45 | 3.2 | 5.6 | 5 | 7.1 | LCO | 3 | 13 | 18 | 29 | 63 | 92% |
| Example 7 | LATP | 0.08 | 0.3 | 1 | 3.8 | 2 | 3.3 | NCM | 0.7 | 5 | 7 | 17 | 49 | 93% |
| Comparative | LATP | / | / | / | / | 0 | / | LCO | 3 | 13 | 18 | / | 70 | 87% |
| Example 1 | | | | | | | | | | | | | | |
| Comparative | LATP | 0.1 | 0.7 | 4 | 7 | 0.2 | 5.7 | LCO | 3 | 13 | 18 | 19 | 71 | 86% |
| Example 2 | | | | | | | | | | | | | | |
| Comparative | LATP | 0.1 | 0.7 | 4 | 7 | 6 | 5.7 | LCO | 3 | 13 | 18 | 19 | 73 | 85% |
| Example 3 | | | | | | | | | | | | | | |
| Comparative | LATP | 1 | 6.5 | 12 | 6.5 | 2 | 1.85 | LCO | 3 | 13 | 18 | 2 | 75 | 83% |
| Example 4 | | | | | | | | | | | | | | |
| Comparative | LATP | 0.1 | 0.4 | 2 | 4.0 | 2 | 5 | LCO | 3 | 13 | 18 | 33 | 74 | 84% |
| Example 5 | | | | | | | | | | | | | | |
| Comparative | LATP | / | / | / | / | 0 | / | NCM | 0.7 | 5 | 7 | / | 55 | 88% |
| Example 6 | | | | | | | | | | | | | | |

From the data comparison between examples 1-7 and comparative examples 1-6 in Table 1, it can be seen that after a specific amount of solid electrolyte is introduced in the positive electrode plate, through the usage of reasonable matching of particles between the positive electrode active material and the solid electrolyte, meeting the conditions of 0.3%≤M≤5% and X:Z being from 5 to 30 as defined in this application, the pores within the positive electrode plate can be utilized to the maximum extent, reducing the number of ineffective closed holes, implementing effective control of lithium-ion transport paths, significantly improving the impedance of the lithium-ion battery, and enhancing its rate performance. In the electrode plate, lithium-ion transport relies on the liquid electrolyte and the solid electrolyte. The conductivity of the solid electrolyte is much lower than the conductivity of the liquid electrolyte. When the solid electrolyte exceeds 5%, if the compacted density of the electrode plate remains unchanged, the volumetric energy density of the battery is lost too much. To avoid the loss of volumetric energy density of the battery, the compacted density of the electrode plate is typically increased, thus reducing the liquid phase channels of the electrolyte, affecting liquid phase transport, and thereby increasing impedance. From the data shown in examples 1-2 and examples 6-7, it can be seen that when the mass percentage or particle size distribution of the solid electrolyte in the positive electrode active material further meets 1%≤M≤5% and X:Z being from 14 to 30, the impedance and rate performance data of the lithium-ion battery are further improved and optimized, achieving better results. From the data shown in comparative examples 1-6, it can be seen that when the mass percentage or particle size distribution of the solid electrolyte in the positive electrode active material does not simultaneously meet 0.3%≤M≤5% and X:Z being from 5 to 30, the impedance of the lithium-ion battery significantly increases, and the rate performance significantly decreases.

TABLE 2

| | Solid Electrolyte | | | | | | | | | | | | | | |
|---|---|---|---|---|---|---|---|---|---|---|---|---|---|---|---|
| | | | | | | Mass | | | | | | D_{V}50 Ratio | | | |
| | | | | | | Percentage | | | | | | D_{V}50 of | | | |
| | | | | | | of Solid | | | | | | Active | Performance | | |
| | | | | | | Electrolyte | | Negative Electrode | | | | Material/ | | Lithium | Rate |
| | | | | | | in Active | | Active Material | | | | D_{V}50 of | Imped- | Precip- | perfor- |
| | Material | D_{V}10 | D_{V}50 | D_{V}99 | D_{V}50/ | Material | D_{V}99/ | Material | D_{V}10 | D_{V}50 | D_{V}99 | Solid | ance | itation | mance |
| | Type | (μm) | (μm) | (μm) | D_{V}10 | (%) | D_{V}50 | Type | (μm) | (μm) | (μm) | Electrolyte | (mohm) | (25° C.) | (2 C) |
| Example 8 | LLZO | 0.1 | 0.8 | 7 | 8 | 3 | 8.75 | C | 6 | 14 | 25 | 18 | 62 | 2.5 C | 93% |
| Example 9 | LLZO | 0.1 | 0.8 | 7 | 8 | 1 | 8.75 | C | 6 | 14 | 25 | 18 | 65 | 2.3 C | 91% |
| Example 10 | LLZO | 0.5 | 2.6 | 8 | 5.2 | 0.3 | 3.1 | C | 6 | 14 | 25 | 5 | 69 | 2.1 C | 88% |
| Example 11 | LLZO | 0.3 | 1.3 | 7.5 | 4.3 | 1 | 5.8 | C | 6 | 14 | 25 | 11 | 67 | 2.2 C | 90% |
| Example 12 | LLZO | 0.2 | 0.9 | 6.5 | 4.5 | 2 | 7.2 | C | 6 | 14 | 25 | 16 | 65 | 2.3 C | 91% |
| Example 13 | LLZO | 0.08 | 0.5 | 4.5 | 6.3 | 5 | 9 | C | 6 | 14 | 25 | 28 | 63 | 2.4 C | 92% |
| Example 14 | LLZO | 0.03 | 0.1 | 0.8 | 3.3 | 2 | 8 | Si | 0.5 | 2 | 6 | 20 | 66 | 2.2 C | 90% |
| Comparative | LLZO | / | / | / | / | 0 | / | C | 6 | 14 | 25 | / | 70 | 2.0 C | 87% |
| Example 7 | | | | | | | | | | | | | | | |
| Comparative | LLZO | 0.1 | 0.8 | 7 | 8 | 0.2 | 8.75 | C | 6 | 14 | 25 | 18 | 71 | 1.9 C | 86% |
| Example 8 | | | | | | | | | | | | | | | |
| Comparative | LLZO | 0.1 | 0.8 | 7 | 8 | 6 | 8.75 | C | 6 | 14 | 25 | 18 | 73 | 1.8 C | 85% |
| Example 9 | | | | | | | | | | | | | | | |
| Comparative | LLZO | 1 | 6.5 | 12 | 6.5 | 2 | 1.85 | C | 6 | 14 | 25 | 2 | 75 | 1.6 C | 83% |
| Example 10 | | | | | | | | | | | | | | | |
| Comparative | LLZO | 0.1 | 0.4 | 2 | 4 | 2 | 5 | C | 6 | 14 | 25 | 35 | 74 | 1.7 C | 84% |
| Example 11 | | | | | | | | | | | | | | | |
| Comparative | LLZO | / | / | / | / | 0 | / | Si | 0.5 | 2 | 6 | / | 68 | 2.0 C | 88% |
| Example 12 | | | | | | | | | | | | | | | |

From the data comparison between examples 8-14 and comparative examples 7-12 in Table 2, it can be seen that after a specific amount of solid electrolyte is introduced in the negative electrode plate, through the usage of reasonable matching of particles between the negative electrode active material and the solid electrolyte, meeting the conditions of 0.3%≤M≤5% and X:Z being from 5 to 30 as defined in this application, the pores within the negative electrode plate can be utilized to the maximum extent, reducing the number of ineffective closed holes, implementing effective control of lithium-ion transport paths, improving the impedance and the rate performance of the lithium-ion battery, and ensuring good lithium precipitation performance. From the data shown in examples 8 and 13, it can be seen that when the mass percentage or particle size distribution of the solid electrolyte in the negative electrode active material further meets 3%≤M≤5% and X:Z being from 14 to 30, the impedance and rate performance data of the lithium-ion battery are further improved and optimized, achieving better results. From the data shown in comparative examples 7-12, it can be seen that when the mass percentage or particle size distribution of the solid electrolyte in the negative electrode active material does not simultaneously meet 0.3%≤M≤5% and X:Z being from 5 to 30, the impedance of the lithium-ion battery significantly increases, the rate performance significantly decreases, and the lithium precipitation capability is also significantly weakened.

TABLE 3

| | Solid electrolyte | | | | | | | | | | | |
|---|---|---|---|---|---|---|---|---|---|---|---|---|
| | | | | | | Mass | | | | | | D_{V}50 Ratio |
| | | | | | | Percentage of | | | | | | D_{V}50 of |
| | | | | | | Solid | | | | | | Active |
| | | | | | | Electrolyte in | | Positive Electrode Active Material | | | | Material/D_{V}50 |
| | Material | D_{V}10 | D_{V}50 | D_{V}99 | D_{V}50/ | Active Material | D_{V}99/ | Material | D_{V}10 | D_{V}50 | D_{V}99 | of Solid |
| | Type | (μm) | (μm) | (μm) | D_{V}10 | (%) | D_{V}50 | Type | (μm) | (μm) | (μm) | Electrolyte |
| Example 15 | LLTO | 0.1 | 0.7 | 2.8 | 7 | 3 | 4 | LCO | 3 | 13 | 18 | 19 |
| Comparative | LLTO | / | / | / | / | 0 | / | LCO | 3 | 13 | 18 | / |
| Example 13 | | | | | | | | | | | | |

TABLE 4

| | Solid Electrolyte | | | | | | | | | | | | | |
|---|---|---|---|---|---|---|---|---|---|---|---|---|---|---|
| | | | | | | Mass | | | | | | D_{V}50 Ratio | | |
| | | | | | | Percentage | | | | | | D_{V}50 of | | |
| | | | | | | of Solid | | | | | | Active | | |
| | | | | | | Electrolyte | | Negative Electrode | | | | Material/ | Performance | |
| | | | | | | in Active | | Active Material | | | | D_{V}50 of | | Rate |
| | Material | D_{V}10 | D_{V}50 | D_{V}99 | D_{V}50/ | Material | D_{V}99/ | Material | D_{V}10 | D_{V}50 | D_{V}99 | Solid | Impedance | performance |
| | Type | (μm) | (μm) | (μm) | D_{V}10 | (%) | D_{V}50 | Type | (μm) | (μm) | (μm) | Electrolyte | (mohm) | (2 C) |
| Example 15 | LLZO | 0.1 | 0.8 | 7 | 8 | 3 | 8.75 | C | 6 | 14 | 25 | 18 | 58 | 95% |
| Comparative | LLZO | / | / | / | / | 0 | / | C | 6 | 14 | 25 | / | 70 | 87% |
| Example 13 | | | | | | | | | | | | | | |

From the data comparison between example 15 and comparative example 13 in Tables 3 and 4, it can be seen that after a specific amount of solid electrolyte is simultaneously introduced in both the positive electrode plate and the negative electrode plate, through the usage of reasonable matching of particles between the positive electrode active material and the solid electrolyte, and between the negative electrode active material and the solid electrolyte, meeting the conditions of 0.3%≤M≤5% and X:Z being from 5 to 30 as defined in this application, the pores within the positive and negative electrode plates can be utilized to the maximum extent, reducing the number of ineffective closed holes, implementing effective control of lithium-ion transport paths, and improving the impedance of the lithium-ion battery, and enhancing its rate performance. Moreover, from the data shown in example 15 and examples 1 and 8, it can be seen that simultaneously introducing a specific content of solid electrolyte into both the positive electrode plate and the negative electrode plate causes further improvement and optimization of impedance and rate performance data of the lithium-ion battery, and thereby achieves better results compared to introducing the solid electrolyte into only the positive electrode plate or the negative electrode plate. In comparative example 13, when no solid electrolyte is introduced in either the positive electrode plate or the negative electrode plate, the impedance of the lithium-ion battery significantly increases, and the rate performance significantly decreases.

Although illustrative embodiments have been demonstrated and described, a person skilled in the art should understand that the foregoing embodiments are not to be construed as limiting this application, and that the embodiments may be changed, replaced, and modified without departing from the spirit, principle, and scope of this application.

What is claimed is:

1. A battery electrode plate, comprising: a current collector and an electrode active layer disposed on at least one surface of the current collector; wherein the electrode active layer comprises an active material, a solid electrolyte, a binder, and a conductive agent; wherein
D_{V}50 of the active material is X, and D_{V}50 of the solid electrolyte is Z, wherein X:Z is from 5 to 30; and based on a mass of the electrode active layer, a mass percentage of the solid electrolyte is M, wherein 0.3%≤M≤5%.

2. The battery electrode plate according to claim 1, wherein X:Z is from 14 to 30;and 1%≤M≤5%.

3. The battery electrode plate according to claim 1, wherein 2 μm≤X≤20 μm; and/or 0.1 μm≤Z≤3 μm.

4. The battery electrode plate according to claim 1, wherein D_{V}10 of the solid electrolyte is E, wherein 0.03 μm≤E≤0.5 μm; and D_{V}99 of the solid electrolyte is F, wherein 0.8 μm≤F≤8 μm; and Z:E is from 3 to 10; and F:Z is from 3 to 10.

5. The battery electrode plate according to claim 4, wherein the battery electrode plate is a positive electrode plate, the active material is a positive electrode active material; the positive electrode active material comprises at least one of lithium cobalt oxide, lithium nickel cobalt manganese oxide, lithium manganese oxide, lithium iron phosphate, or lithium manganese iron phosphate; and
the solid electrolyte comprises an oxide solid electrolyte or a metal halide solid electrolyte; wherein
the oxide solid electrolyte comprises at least one of perovskite-type, anti-perovskite-type, garnet-type, NASICON-type, LISICON-type, or LiPON-type; and/or
the metal halide solid electrolyte comprises at least one of Li₃YBr_{5.7}F_{0.3}, Li₂ZrCl₆, or Li₃ScCl₆.

6. The battery electrode plate according to claim 4, wherein the battery electrode plate is a negative electrode plate, the active material is a negative electrode active material; the negative electrode active material is selected from at least one of graphite, silicon, silicon alloy, or tin alloy; and
the solid electrolyte comprises an oxide solid electrolyte or a metal halide solid electrolyte; wherein
the oxide solid electrolyte comprises LLZO or LiPON; and/or
the metal halide solid electrolyte comprises at least one of Li₃YBr_{5.7}F_{0.3}, Li₂ZrCl₆, or Li₃ScCl₆.

7. The battery electrode plate according to claim 5, wherein D_{V}10 of the positive electrode active material is A, wherein 0.7 μm≤A≤3 μm; D_{V}99 of the positive electrode active material is B, wherein 7 μm≤B≤45 μm; and A<F.

8. The battery electrode plate according to claim 6, wherein D_{V}10 of the negative electrode active material is C, wherein 0.5 μm≤C≤6 μm; Dᵥ99 of the negative electrode active material is D, wherein 6 μm≤D≤50 μm; and C<F.

9. The battery electrode plate according to claim 1, wherein a conductivity of the solid electrolyte is greater than or equal to 0.1 mS/cm.

10. The battery electrode plate according to claim 2, wherein 2 μm≤X≤20 μm; and/or 0.1 μm≤Z≤3 μm.

11. A secondary battery, comprising the battery electrode plate according to claim 1.

12. The secondary battery according to claim 11, wherein X:Z is from 14 to 30; and 1%≤M≤5%.

13. The secondary battery according to claim 11, wherein 2 μm≤X≤20 μm; and/or 0.1 μm≤Z≤3 μm.

14. The secondary battery according to claim 11, wherein D_{V}10 of the solid electrolyte is E, wherein 0.03 μm≤E≤0.5 μm; and D_{V}99 of the solid electrolyte is F, wherein 0.8 μm≤F≤8 μm; and
Z:E is from 3 to 10; and D_{V}99 of the solid electrolyte is F, wherein F:Z is from 3 to 10.

15. The secondary battery according to claim 14, wherein the battery electrode plate is a positive electrode plate, the active material is a positive electrode active material; the positive electrode active material comprises at least one of lithium cobalt oxide, lithium nickel cobalt manganese oxide, lithium manganese oxide, lithium iron phosphate, or lithium manganese iron phosphate; and
the solid electrolyte comprises an oxide solid electrolyte or a metal halide solid electrolyte; wherein
the oxide solid electrolyte comprises at least one of perovskite-type, anti-perovskite-type, garnet-type, NASICON-type, LISICON-type, or LiPON-type; and/or
the metal halide solid electrolyte comprises at least one of Li₃YBr_{5.7}F_{0.3}, Li₂ZrCl₆, or Li₃ScCl₆.

16. The secondary battery according to claim 14, wherein the battery electrode plate is a negative electrode plate, the active material is a negative electrode active material; the negative electrode active material is selected from at least one of graphite, silicon, silicon alloy, or tin alloy; and
the solid electrolyte comprises an oxide solid electrolyte or a metal halide solid electrolyte; wherein
the oxide solid electrolyte comprises LLZO or LiPON; and/or
the metal halide solid electrolyte comprises at least one of Li₃YBr_{5.7}F_{0.3}, Li₂ZrCl₆, or Li₃ScCl₆.

17. The secondary battery according to claim 15, wherein D_{V}10 of the positive electrode active material is A, wherein 0.7 μm≤A≤3 μm; D_{V}99 of the positive electrode active material is B, wherein 7 μm≤B≤45 μm; and A<F.

18. The secondary battery according to claim 16, wherein D_{V}10 of the negative electrode active material is C, wherein 0.5 μm≤C≤6 μm; D_{V}99 of the negative electrode active material is D, wherein 6 μm≤D≤50 μm; and C<F.

19. The secondary battery according to claim 11, wherein conductivity of the solid electrolyte is greater than or equal to 0.1 mS/cm.

20. An electronic apparatus, comprising the secondary battery according to claim 11.
